(19) United States
(12) Patent Application Publication
(10) Pub. No.: US 2015/0040192 A1
(43) Pub. Date: Feb. 5, 2015

(54) GRADUATED ACCESS MULTI-PASSWORD AUTHENTICATION

(71) Applicant: Michael Christopher Kobold, Indialantic, FL (US)

(72) Inventor: Michael Christopher Kobold, Indialantic, FL (US)

(21) Appl. No.: 13/956,148

(22) Filed: Jul. 31, 2013

(51) Int. Cl. H04L 29/06

(52) U.S. Cl. CPC H04L 63/083
USPC 726/4

(57) ABSTRACT

Methods and systems for accessing computer data and systems require different sequential and serial passwords to drive a user into a tiered set of sub-accounts of graduated access. At the same time, the tiered hierarchy of access acts as a honey pot system where remote intruders would statistically tend to break through the slightly less secure passwords first, triggering the notification system upon entry into the restricted or firewalled honey pot or virtual systems. With this system, the system administrator can manage multiple sessions for each user where the passwords are of a different level of security based on commercially available password strength tools. The system administrator creates the less secure passwords and lower access sub-accounts and optionally allows users to have such lower levels.

### STATEMENT OF GOVERNMENT INTEREST

This invention may be used by or for the US Navy for government purposes without the payment of royalties thereon or therefore.

### BACKGROUND OF THE INVENTION

The present invention relates to a graduated access multi-password authentication system and, more particularly, to methods and systems to require different sequential and serial passwords to drive a user into a tiered set of sub-accounts of graduated access. At the same time, the tiered hierarchy of access acts as a honey pot system where remote intruders would statistically tend to break through the slightly less secure passwords first, triggering the notification system upon entry into the restricted or firewalled honey pot or virtual systems.

In current systems, entities seeking unauthorized entry will see the user's data and have their access if they are able to obtain or ‘crack’ the password. A similar system that uses password hints to allow a user entry results in a multiple answer authentication (‘serial multi-passwords’) system to provide the user access to the same account (sub-account) and level of access.

If a user has been compromised and is forced to provide a user ID and password under duress, in current systems, there is no way to provide access to protect the user, while such access does not result in the user's full data and privileges being accessed.

As can be seen, there is a need for a graduated access multi-password authentication system that permits tiered access to a user account, where less secure passwords can send a session into a type of honey trap.

### SUMMARY OF THE INVENTION

In one aspect of the present invention, a graduated access multi-password authentication system comprises a tiered account system including a plurality of accounts for a user, where the plurality of accounts includes at least one full access tier and at least one untrusted guest tier; a tiered access system providing a plurality of access privileges for each of the plurality of accounts, where at least one full access tier has access privileges for user authorized data and at least one untrusted guest tier provides a user quarantine access privilege; a tiered authority system providing a plurality of authority privileges for each of the plurality of accounts, where at least one full access tier has read, write and execute privileges and at least one untrusted guest tier has limited or no read, write and execute privileges; and a tiered authentication system providing a plurality of authentication passwords, where at least one full access tier has a password of a first strength and at least one untrusted guest tier has a password of a second strength wherein the first strength is more strong that the second strength.

In other aspects of the invention subsequent tiers, if the system administrator defines them, have lower password strengths in a graduated fashion.

In another aspect of the present invention, a method for providing access to a computer system comprises setting a plurality of accounts for a user, where the plurality of accounts includes at least one full access tier and at least one untrusted guest tier; providing a plurality of access privileges for each of the plurality of accounts, where at least one full access tier has access privileges for user authorized data and at least one untrusted guest tier provides a user quarantine access privilege; providing a plurality of authority privileges for each of the plurality of accounts, where at least one full access tier has read, write and execute privileges and at least one untrusted guest tier has limited or no read, write and execute privileges; providing a plurality of authentication passwords, where at least one full access tier has a password of a first strength and at least one untrusted guest tier has a password of a second strength wherein the first strength is more strong that the second strength; and receiving a password from a user and assigning one of the plurality of accounts to the user based on the password entered.

These and other features, aspects and advantages of the present invention will become better understood with reference to the following drawings, description and claims.

### BRIEF DESCRIPTION OF THE DRAWINGS

FIG. 1 is a schematic representation of tiered relationships in a graduated access multi-password authentication system between accounts, access, authority and authentication, according to an exemplary embodiment of the present invention;

FIG. 2 is a schematic representation illustrating the temporary use of a graduated access multi-password authentication system within a conventional authentication system according to an exemplary embodiment of the present invention;

FIG. 3 is a schematic representation illustrating the graduated access multi-password authentication system for an assigned authenticated session;

FIG. 4 is a graphical representation showing that sensitivity to password strength occurs in a central zone of probability of cracking that has plateaus on either side. The different lines represent the parametric length of sub-strings (k=1, 2, 3, 4), used in Markov chain-based attacks on probabilistic context-free grammars (PCFGs);

FIG. 5 is a graphical representation showing the probability of cracking three password levels A1 to A3; and

FIG. 6 is a graphical representation showing the probability that password level A2 fails before password level A1, plotted on the ordinate, is a very small value. This figure uses a simple form of password strength only as an example. This example method is to increase the number of characters by one character for each higher level of strength required, and vice versa. The plot in FIG. 6 shows that the calculated value of probability that the system will allow an unauthorized entry into a higher level of password strength is negligible.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides methods and systems that require different sequential and serial passwords to drive a user into a tiered set of sub-accounts of graduated access. At the same time, the tiered hierarchy of access acts as a honey pot system where remote intruders would statistically tend to break through the slightly less secure passwords first, triggering the notification system upon entry into the restricted or firewalled honey pot or virtual systems. With this system, the system administrator can manage multiple sessions for each user where the passwords are of a different level of security based on commercially available password strength tools. The system administrator creates the less secure passwords and lower access sub-accounts and optionally allows users to have such lower levels.

In the event that a user has been compromised and is forced to provide a password under duress, the intruder is more likely to know for certain only the user ID. Under the graduated access multi-password authentication system of the present invention, intruders and their allies might be aware of the login ID, but not the correct password. A user under duress can provide the intruder with a less secure password, providing access to a honey pot system, where the intruder can be monitored and valuable data remains secure. Moreover, with knowledge of the existence of the graduated access multi-password authentication system of the present invention, attempts to crack passwords may be reduced, as an intruder may not know what level they have gained access to, and the data contained at that level may be incorrect and/or not useful.

With the graduated access multi-password authentication system of the present invention, all passwords can be sufficiently strong but with a small enough difference in strength that graduated access into different tiers is possible. This allows the use of automation to produce honey pot type tiers which might, for example, only be two in number. Both exterior attacks and interior influence pressure (belligerence or duress) are trapped from entering secured systems by having slightly less secure passwords send the session to a type of honey trap, such as a virtual box or merely a restricted sub-account. At the same time, use of passwords beneath the most secure password can automatically initiate an alarm to proper authorities in order to initiate surveillance or protective action.

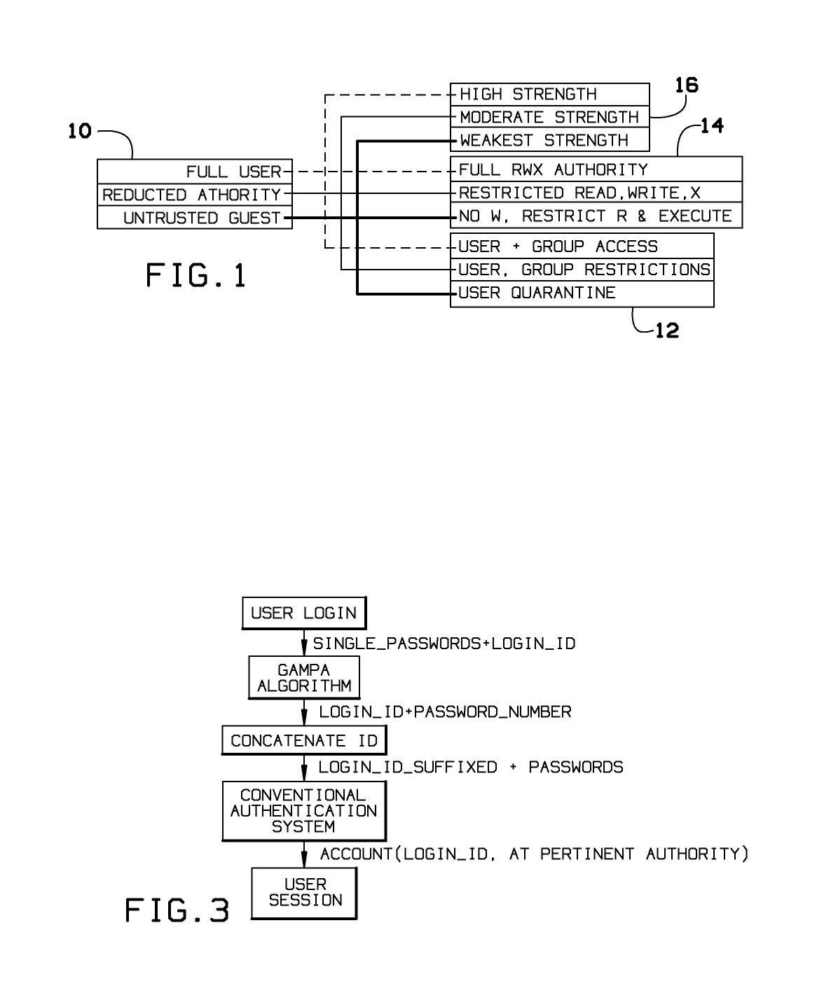

Referring now to FIG. 1, a tiered account system 10 can include a plurality of tiers, including a full user tier, a restricted authority tier, and an untrusted guest tier. Each tier of the account system 10 can be assigned a password (16), typically, the password strength is highest for the full user access tier and lowest for the untrusted guest tier.

A tiered access system 12 can be linked to the tiered account system 10, where the access can be determined by the tier into which the user enters (based on the password entered). For the full user access tier, the user can have full access, such as, for example, user and group access. For the reduced/restricted authority tier, the user can have access to the user's data but limited group access, for example. For the untrusted guest access tier, the user may be placed in user quarantine, such as into a honey pot type of system where the user's access can be monitored. The number of and trust magnitude of different tiers are set by the system administrator. Several default systems are possible. One simple default system would have passwords for higher trust levels be passwords whose mandatory minimum length contains one more character for each level.

A tiered authority system 14 can be linked to the tiered account system 10, where full user access tiers can have access to full read and write privileges, restricted authority tiers can have access to restricted read and write privileges, and the untrusted guest tier can have no write access and restricted read access and restricted execute access.

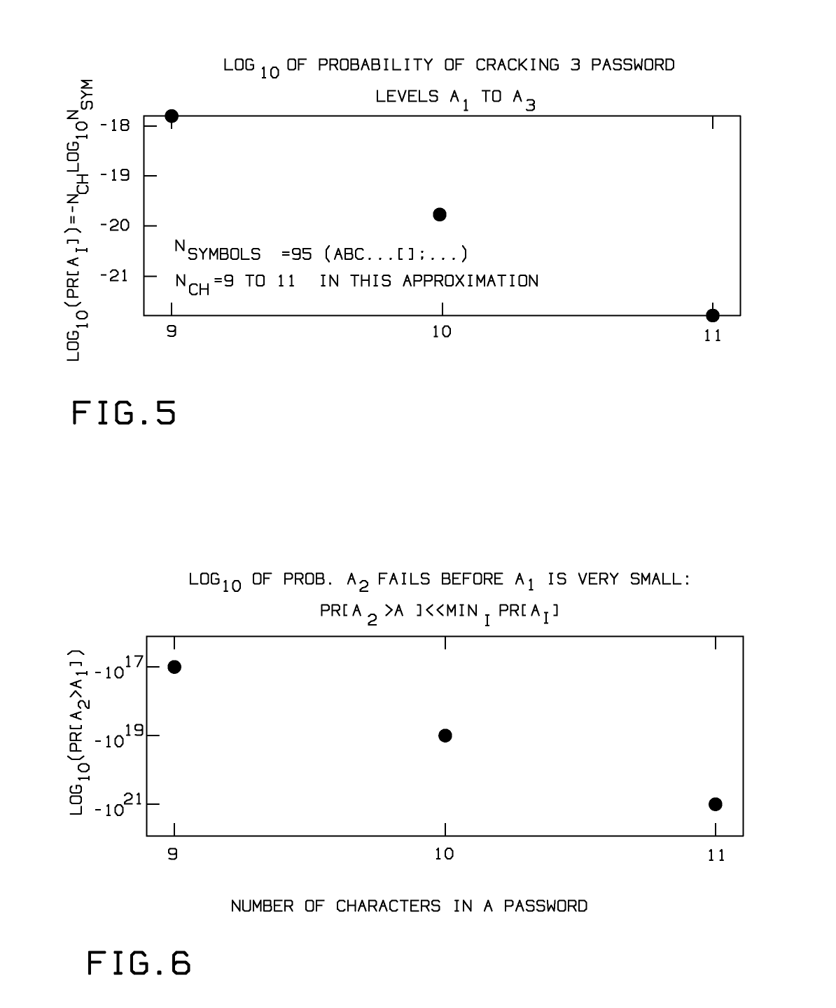

A tiered authentication system 16, as described above, can have a high strength password assigned for access to the full user access tier, a moderate strength password assigned to the restricted access tier and a lower strength password assigned to the untrusted guest tier. While the term “lower strength” is used, this password is not necessarily low strength as FIGS. 5 and 6 attest, but is lower in strength than those used to access the higher tiers.

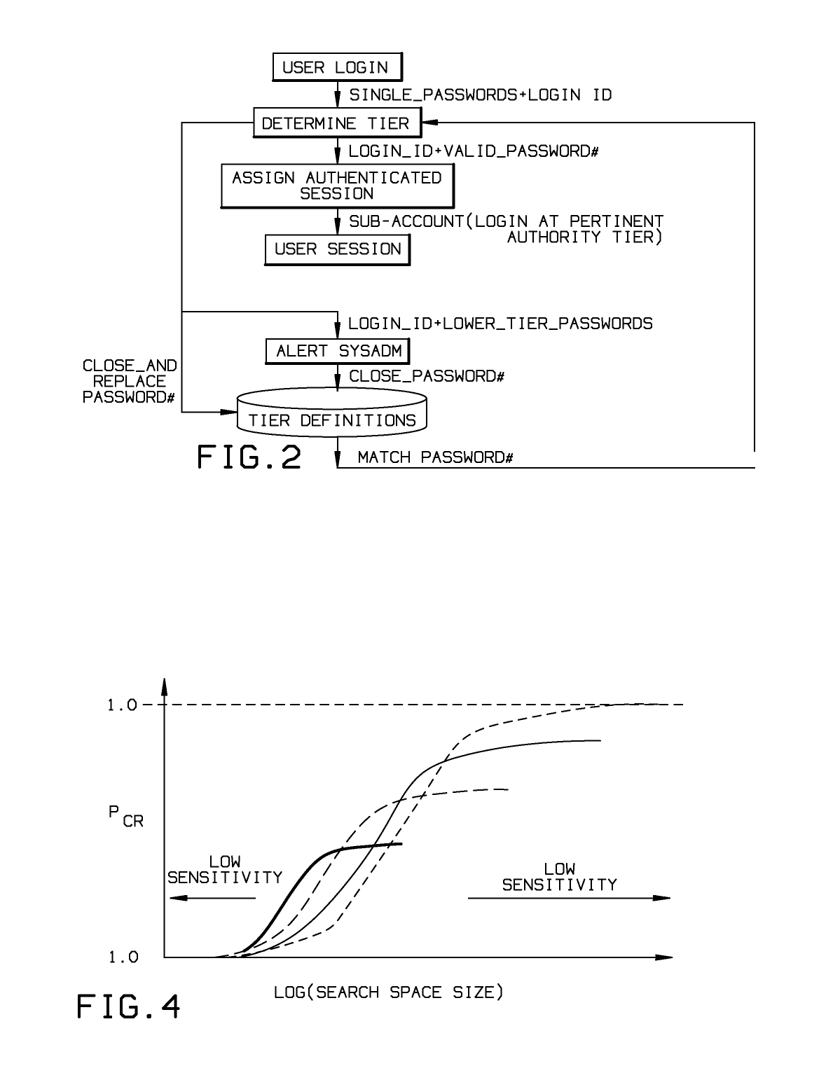

The graduated access multi-password authentication system of the present invention can be used as an add-on in conventional password systems, as shown in FIG. 2, or can be incorporated into a newly designed and developed system. A hybrid concept allows for using existing commercial authentication along with the graduated access multi-password authentication system of the present invention to create a hybrid system until the user is ready to move to a full graduated access multi-password authentication system.

FIG. 4 shows the general behavior of password strength where, at some point in a particular password cracking algorithm's performance, the fraction of passwords cracked, P_{CR}, reaches a horizontal asymptote of maximum probability of password failure. The plot is easier to understand by considering the right side first—the more time and computer resources one has, the more likely one is able to crack the code. Larger word size is one method to increase password strength, which serves as an example of increased strength in this description.

Above a threshold set just below the horizontal asymptote larger word size or search space provides negligible improvement in the performance. FIG. 4 shows the general behavior of three different data sets for Markov chain-based attacks on probabilistic context-free grammars (PCFGs). The different lines represent the parametric length of sub-strings used in the Markov modeling. More to the point, in the opposite direction of decreasing size, all methods appear to converge to zero probability of guessing a password as the size of the search space is reduced; the computer resources were insufficient to crack the passwords.

The resulting password attack performance curves (FIG. 4) thus show how the weakest password will crack first. Calculated values read on the ordinate of FIG. 5 show the probability of cracking passwords of length N_{ch} decreases by approximately two orders of magnitude for each added character. But the probability that any stronger password cracks first before the weakest is a different, more subtle calculation. FIG. 6 plots the logarithm of this approximate password “trapping” probability, −(N_{symbols})^{Nch}, with an alphabet of N_{symbols}=95. Since the resultant probability (10)^{-Nsymbols})^{Nch} is very small, the exceptions to graduated access are negligible, only approximately one attack out of ten billion billion attacks on the lower trust level password will crack the next higher level first. In any super-automated system where high frequency of attempts is expected the system administrator merely needs to add one more level for approximately 19 more orders of magnitude of protection.

When the system of the present invention prompts a user to change a password, conventional password management systems usually require the user to enter their existing password. In the system of the present invention, the entry of a password identifies the tier of the password the user or system is changing. The system does not require any significant change to the outward appearance of password prompt systems or software modules.

It should be understood, of course, that the foregoing relates to exemplary embodiments of the invention and that modifications may be made without departing from the spirit and scope of the invention as set forth in the following claims.

What is claimed is:

1. A graduated access multi-password authentication system comprising:
a tiered account system including a plurality of accounts for a user, where the plurality of accounts includes at least one full access tier and at least one untrusted guest tier;
a tiered access system providing a plurality of access privileges for each of the plurality of accounts, where at least one full access tier has access privileges for user authorized data and at least one untrusted guest tier provides a user quarantine access privilege;
a tiered authority system providing a plurality of authority privileges for each of the plurality of accounts, where at least one full access tier has read, write and execute privileges and at least one untrusted guest tier has limited or no read, write and execute privileges; and
a tiered authentication system providing a plurality of authentication passwords, where at least one full access tier has a password of a first strength and at least one untrusted guest tier has a password of a second strength wherein the first strength is more strong that the second strength.

2. The graduated access multi-password authentication system of claim 1, wherein the plurality of accounts includes at least one restricted access tier.

3. The graduated access multi-password authentication system of claim 1, wherein the user quarantine is a honey pot type of access, where an untrusted guest is monitored and security action is initiated.

4. The graduated access multi-password authentication system of claim 1, wherein there is at least one untrusted guest tier that has no write access and restricted read and execute privileges.

5. The graduated access multi-password authentication system of claim 1, wherein the system is hybridized with a convention authentication system.

6. The graduated access multi-password authentication system of claim 1, wherein the plurality of authentication passwords have a minimum length requirement that contains one additional character at each higher level of the plurality of accounts, or an equivalent system producing passwords that monotonically increase in strength.

7. A method for providing access to a computer system, comprising:
setting a plurality of accounts for a user, where the plurality of accounts includes at least one full access tier and at least one untrusted guest tier;
providing a plurality of access privileges for each of the plurality of accounts, where at least one full access tier has access privileges for user authorized data and at least one untrusted guest tier provides a user quarantine access privilege;
providing a plurality of authority privileges for each of the plurality of accounts, where at least one full access tier has read, write and execute privileges and at least one untrusted guest tier has limited or no read, write and execute privileges;
providing a plurality of authentication passwords, where at least one full access tier has a password of a first strength and at least one untrusted guest tier has a password of a second strength wherein the first strength is more strong that the second strength; and
receiving a password from a user and assigning one of the plurality of accounts to the user based on the password entered.

8. The method of claim 7, wherein the plurality of accounts includes at least one restricted access tier.

9. The method of claim 7, wherein the user quarantine is a honey pot type of access, where an untrusted guest is monitored and security action is initiated.

10. The method of claim 7, further comprising hybridizing the plurality of accounts with a convention authentication system.
